(19) United States
(12) Patent Application Publication
(10) Pub. No.: US 2019/0050882 A1
(43) Pub. Date: Feb. 14, 2019

(54) MOBILE NETWORKED COMMUNICATION GAME

(71) Applicant: Robert Cohen, West Hollywood, CA (US)

(72) Inventor: Robert Cohen, West Hollywood, CA (US)

(21) Appl. No.: 15/912,418

(22) Filed: Mar. 5, 2018

Related U.S. Application Data
(63) Continuation of application No. 12/191,714, filed on Aug. 14, 2008, now abandoned.
(60) Provisional application No. 60/955,817, filed on Aug. 14, 2007.

(51) Int. Cl. G06Q 30/02; A63F 13/655; A63F 13/795

(52) U.S. Cl. CPC G06Q 30/0209; A63F 13/795; A63F 13/655

(57) ABSTRACT

A game in which game players receive clues as to the identity of target items, and locate the target items, and take pictures of the target items. The pictures are provided to a central unit, which determines winners of the game. The winners of the game may be determined based on the game player who utilizes the least amount of time to locate, image, and submit pictures of all the target locations, or those who submit the most pictures of different target items in a predefined time period.

### CROSS REFERENCE TO RELATED APPLICATION(S)

This application claims the benefit of the filing date of U.S. Provisional Patent Application No. 60/955,817, filed Aug. 14, 2007, the disclosure of which is incorporated by reference herein.

### BACKGROUND OF THE INVENTION

The present invention relates generally to a game, and more particularly to a game utilizing wireless communication capable devices with a camera.

Wireless communication devices allow people to communicate with one another while on the go, whether commuting, out and about on daily errands or even during long distance travel. Through the use of text messaging capability, e-mail capability, and image capability, in addition to providing voice communications, these devices have increased the ability of individuals to provide information to one another. The ease of use of these devices, the broad geographic areas in which they are effective, and the capabilities they may have, may be considered a revolution in the ability of people to stay in communication with one another.

While wireless communications devices may have greatly increased the ability of individuals to communicate while on the go, these devices may have done little to provide reasons for people to actually go to places.

### BRIEF SUMMARY OF THE INVENTION

The present invention provides a networked mobile game. In one aspect the invention provides a method of providing for a mobile game, comprising: providing a plurality of clues regarding a plurality of items; receiving images allegedly of the plurality of items; and

determining a game status based on correspondence between the images and the plurality of items. In another aspect the invention provides a system for providing game functions, comprising: a computer configured by program instructions in memory of the computer to provide clues as to target items to game players using mobile communication devices with imaging capabilities, receive images of alleged target items, record a time of submission of the images, post the images to a web page, and determine a winner of the plurality of game players. In another aspect the invention provides a method of playing a game, comprising: receiving information of a plurality of target items; taking a picture of each of the target items; and sending each picture to a central unit.

These and other aspects of the invention are more fully comprehended upon review of this disclosure.

### BRIEF DESCRIPTION OF THE FIGURES

FIG. 1 is a block diagram of a system implementing a game in accordance with aspects of the invention;

FIG. 2 is a flow diagram of a process of performing game related functions in accordance with aspects of the invention;

FIG. 3 illustrates an image expected to be captured in accordance with aspects of the invention;

FIG. 4 is a further block diagram of a system implementing a game in accordance with aspects of the invention;

FIG. 5 is a further flow diagram of a process of performing game related functions in accordance with aspects of the invention; and

FIG. 6 is a further flow diagram of a process of in accordance with aspects of the invention.

### DETAILED DESCRIPTION

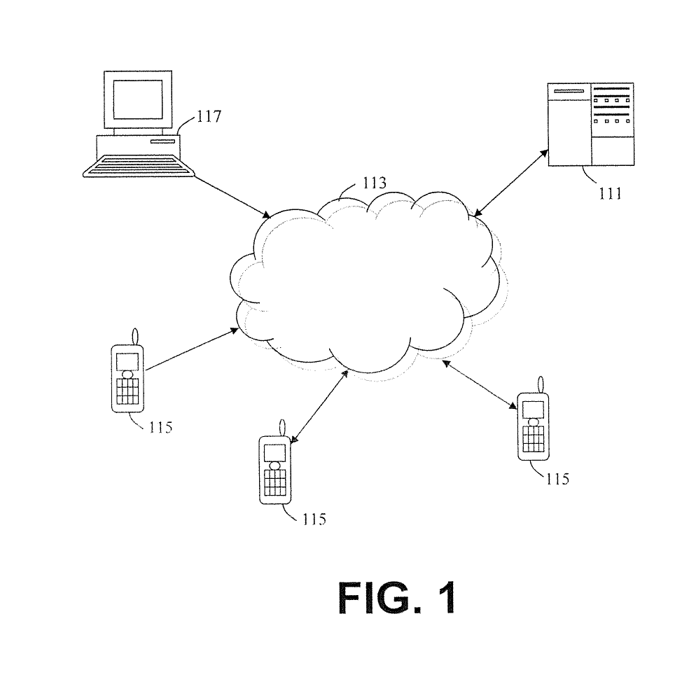

FIG. 1 is a block diagram of a system implementing a game in accordance with aspects of the invention. In FIG. 1 a server computer 111 is coupled to a network 113. The server computer is configured by program instructions of a game to perform game related functions, and as used herein depending on the context the term “server” may refer to either a computer unit forming the server computer or, as may be considered more technically correct, software executing on the server computer. Generally the server computer includes one or more processors, memory available to the one or more processors, network interface cards or the like, and possibly other components often used with or forming part of a computer.

The network is shown for clarity as a single network, such as the Internet. In various embodiments the network may comprise several different networks, which may be data coupled together by intervening networks. For example, the server may be coupled to a plurality of networks, such as phone networks, the Internet, private networks, as well as local networks of which the server may be a part. In many instances the various separate networks may share common physical infrastructure, for example Internet communications and phone communications may be transferred over common fiber optic lines or wireless data links, for example.

A plurality of communication capable imaging devices 115 are also coupled to the network. In most embodiments the communication capable imaging devices are cell phones including cameras, which are commonly available and used. In many instances such cell phones provide voice and data communication capabilities, and the data may be for example images or other multimedia information. The imaging devices generally provide digital images, for example using charge coupled devices (CCDs) or the like. In some embodiments, however, standalone camera devices may be used, with the standalone camera devices coupled to or able to download images for transfer to a communication device coupled to the network.

In most embodiments the server computer provides information regarding items to locate to the communication capable imaging devices. The information is generally provided over the network. The information regarding items to locate may be in various forms, and may simply specify an item to locate or consist of or comprise a clue as to the identity of an item to locate. For example the information regarding items to locate may be identification of the location of a particular place to visit, a particular item to find, or other information. The information regarding items to locate may be as simple as providing street addresses of particular stores or latitude and longitude of particular locations, or the information may be in the form of riddle, or an image or multimedia presentation relating to an item or a location. In addition, in some embodiments, the information may relate to any of a plurality of items or locations, for example the information may direct recipients of the clue to any car of a particular color, make, or model, or any store of a chain of stores.

Users of the communication capable imaging devices, in most embodiments cell phones, attempt to determine the item to locate and locate the item or travel to a location indicated by a corresponding clue. The users may be individual game players, or the users may be organized into teams of game players, allowing for either or both individual and/or team play. After locating an item, users of the cell phones capture an image, generally by taking a picture using their cell phones, and transmit the image to the server computer by way of the network. The server computer, or a game administrator or the like, determines if the image is of the item. In some embodiments the image must include the user, a member of a team playing the game, or a physical icon specific to the user or the team, preferably to increase the likelihood that the user or team actually was present at the location of the item.

In some embodiments users are provided a complete list of items to locate, which may be termed target items, or clues for a complete list of items to locate before or at the start of a game. In some embodiments users are provided information regarding an item in a sequential fashion during game play, with information for a subsequent item provided after an image of a prior item is successfully provided to the server computer. In some embodiments users are awarded points or some other reward for providing an image of an item, and in some embodiments users are declared winners of a game if they are the first of multiple users or user groups to successfully provide images of each of a plurality of items referenced by the information regarding the items. In some embodiments, users may simply play the game in a timed manner, competing against only the clock or competing against other users or user groups playing at different times with respect to the same or a common set of information regarding the items.

In some embodiments a third party may request that items or locations associated with the third party be included in the game, and may make payments to an operator of the game to the items or locations included in the game, or provide benefits to users playing the game to encourage users to play the game. For example, a convenience store operator may make a payment to a game operator for including their convenience store in the game, thereby encouraging individuals to visit their convenience store, or the convenience store operator may provide discounts to game players who visit their location. In some embodiments the third party may not place their location in the game, but instead may place a nearby location in the game, perhaps in the hope that game players who travel to the nearby location may also utilize the establishment of the third party.

In some embodiments a personal computer 117 is also coupled to the network. In general multiple personal computers will be coupled to the network. Information regarding items may be provided to the personal computer, and game players may find it more convenient to obtain some or all of the information regarding the items using the personal computer. For example, personal computers often have printers and the like readily available, and in many instances multimedia presentations may be more readily experienced using personal computers, as opposed to, for example, cell phones. In addition, in some embodiments each game player, or group of game players, may have or be provided a web page. The web page may be provided images uploaded by the game players, for example to record their progress in the game and to allow others to track the same.

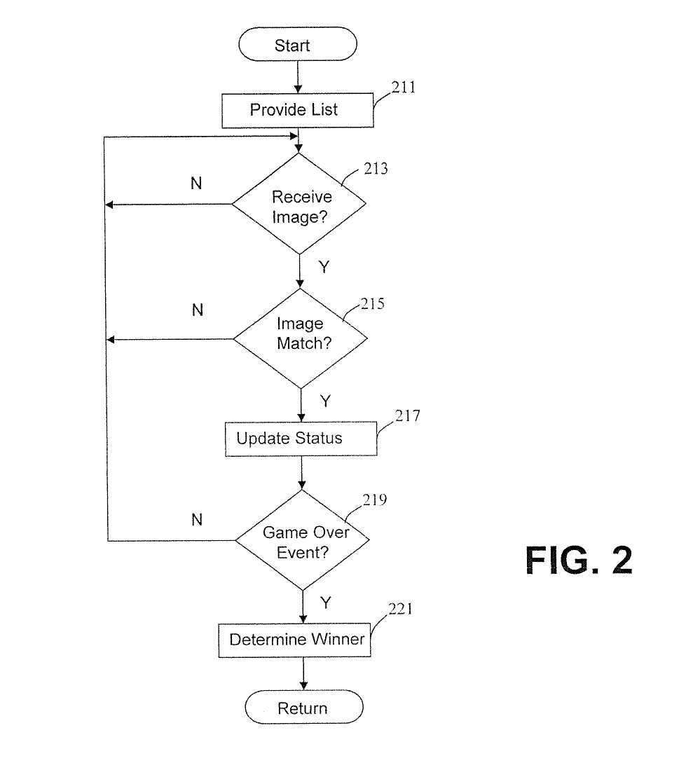

FIG. 2 is a flow diagram of an embodiment of a process of performing game related functions. In some embodiments the process is performed by the server computer of FIG. 1, generally by way of program instructions stored in memory and which configure a processor of the server computer to perform the functions.

In block 211 the process provides a list of information for target items. In some embodiments the list is in the form of clues, with one clue for each item, and in some embodiments multiple clues for each item. In some embodiments the list more clearly specifies the items. The list is provided to game players. In various embodiments the list may be provided to e-mail accounts of game players, transmitted to cell phones of game players, or by posted to a web page accessible to game players by way of, for example, the Internet. In some embodiments the list may also provide a weighting of items, indicating that some items may have a greater or lesser value, for example as indicated by a point value associated with each item. In addition, bonus items may be associated with some items, with inclusion in the image of both the bonus item and the item providing a game player additional points or some other award.

In block 213 the process determines if an image has been received from a game player. If not, the process awaits receipt of an image. If an image has been received, in block 215 the process determines if the image is of a target item. The process may do this through comparison of the image, or portions of the image, with a reference image. In some embodiments a system operator, game administrator, or other person may view the received image and determine if the image is of a target item.

If the image is not of a target item the process returns to block 213 and awaits receipt of an image. If the image is of a target item, in block 217 the process updates game status. For example, in most embodiments the process saves in computer memory an indication that the game player or game player group that provided the image successfully found the target item. Generally, the game player or game player group is notified that they have successfully located a target item, and other game players or third parties may also be notified. In some embodiments, for example when clues for target items are provided sequentially, a clue to a next target item may also be provided to the game player or game player group.

In block 219 the process determines if a game over event has occurred. If no game event has occurred the process returns to block 213 and awaits receipt of an image. In most embodiments a game over event occurs when a game player or game player group has successfully traveled to each of the target items of the list of target items. In some embodiments, a game over event may instead or in addition occur after an end of a timed period, for example a time period beginning when the target list or information of the target list is first provided or made available to game players.

In block 221 the process determines a winner of the game. In most embodiments the winner of the game is the game player or group of game players that either has first successfully located each of the target items or has successfully located the most target items. In some embodiments points are assigned for target items, and the game player or team of game players that has located target items worth the most points is the winner. In addition, in some embodiments points may accumulate from game to game, for example allowing for a series or season of games, and in some embodiments game players or teams of game players may be allowed to enter invitation only games or otherwise be awarded a prize. The process thereafter returns.

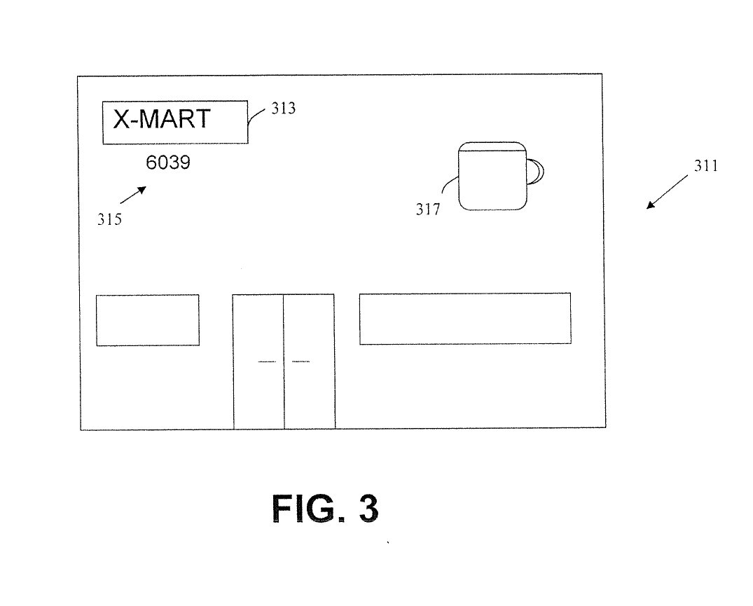

FIG. 3 is an example image of a target item, in this case a location. The target item shown in FIG. 3 is an X-Mart building 311. The exterior of the building includes signage 313 with the text “X-Mart”. The target item also includes a number of a street address 315 of the target item, and additional signage 317 depicting a coffee cup. In some embodiments the image of the target item is provided as a clue to the target item, and images received from game players must largely correspond to the image provided as the clue. In some embodiments images provided by game players are to include portions of the image as seen in FIG. 3, for example the number of the street address, the signage, or the additional signage. Requiring that images provided by game players include such portions may be beneficial in increasing ease of automatic determination of whether a received image matches a target item, for example using object or pattern recognition software, which may make use of image level lines or other features of the image.

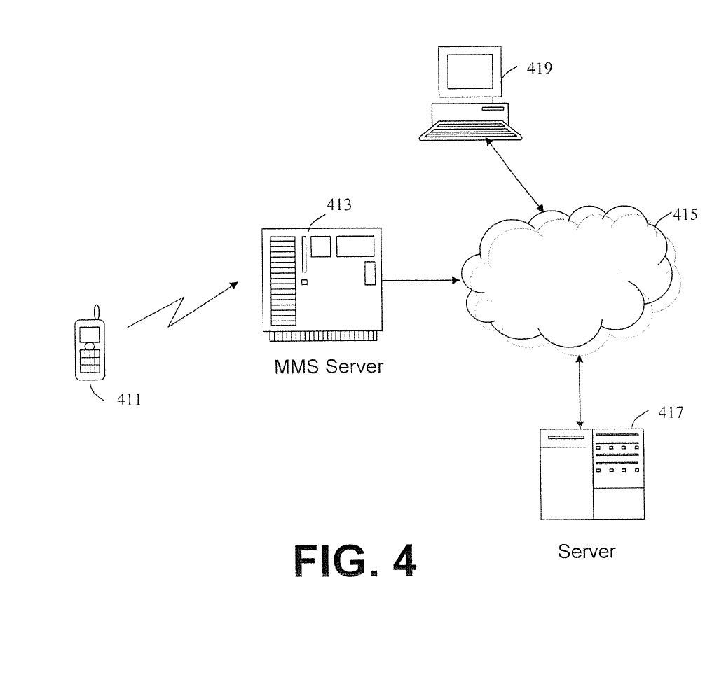

FIG. 4 is a block diagram of a further system useful in embodiments of the invention. A combined camera and cell phone 411 is in data communication with a media messaging server 413. Generally the cell phone communicates with the media messaging server by way of a phone network. The media messaging server is generally configured to process test and media messages, including images, from cell phones and the like. The media messaging services (MMS) server is in data communication with a network 415, as is a server 417 configured to provide game related functions. The server may be software executing on a computer along with other software providing a variety of application functions, or the server may have as its primary application providing game related functions. In addition, in various embodiments the server may be part of a networked environment, with multiple servers providing the game related functions. A personal computer 419 is optionally coupled to the network.

In operation a game player uses the cell phone to obtain an image of a target location, and causes the cell phone to transmit the image to the server. This may be accomplished by way of sending the image to a phone number associated with the server, or otherwise. The transmitted image is received by the MMS server, which forwards the image to the game server over the network 415. The game server determines, either by way of programming or by way of operator input, whether the image is of the target item. If the image is of the target location the game server provides a message for the cell phone and, optionally, updates a web page accessible by the personal computer.

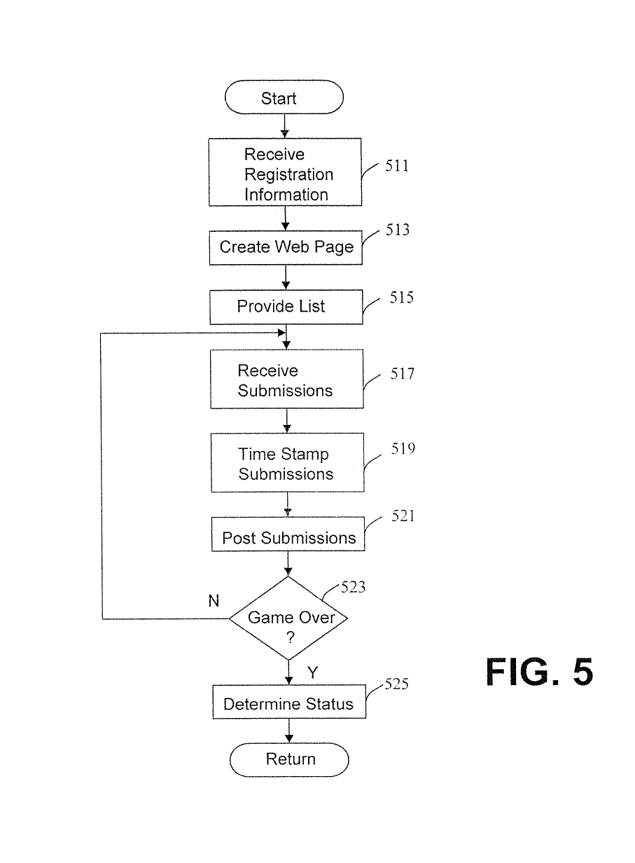

FIG. 5 is a flow diagram of a process of performing game functions. In some embodiments the process is performed by the server computer of FIG. 1, or a processor of the server computer, or the server of FIG. 4.

In block 511 the process receives registration information. The registration information may include information of a game player or a common group of game players. In some embodiments the registration information includes a player or group name, a cell phone number or set of cell phone numbers associated with the group, and other information related to the game players, and, in many embodiments, a particular game which the game player or group of game players desires to play.

In block 513 the process creates a web page for the game player or group of game players. The web page may include an identification of the player or group, a status of game play progress for the player or group, and images of target items provided by the player or group, and other information.

In block 515 the process provides a list of information relating to target items. For convenience, the process of FIG. 5 shows the list of information as being provided in bulk, in many embodiments however the information is provided for a single target item or group of target items at a time, with for example subsequent information provided after prior target items have been located by a particular game player or group of game players.

In block 517 the process receives a submission. The submission in many embodiments is an image of a target item, or possibly an image of an alleged target item. In some embodiments the submission may be text or other information available at a location of a target item. In block 519 the process time stamps the submission. The time stamp may be provided by inserting time information onto the image, by way of storing a time value in a manner such that the time value is associated with the image, in a record of a database for example, or by other methods. In block 521 the process posts the submission to the web page associated with the player or group who submitted the image.

In block 523 the process determines if the game is over. The game may be over, for example, if a player or group has submitted an image for each of the target items in the game, or for example if a predefined time limit for the game has been reached. If the game is not over the process returns to block 517 to receive further submissions. If the game is over the process proceeds to block 525 and determines status of the game. In some embodiments determining status of the game comprises determining a winner of the game, in some embodiments other aspects of game play may be determined.

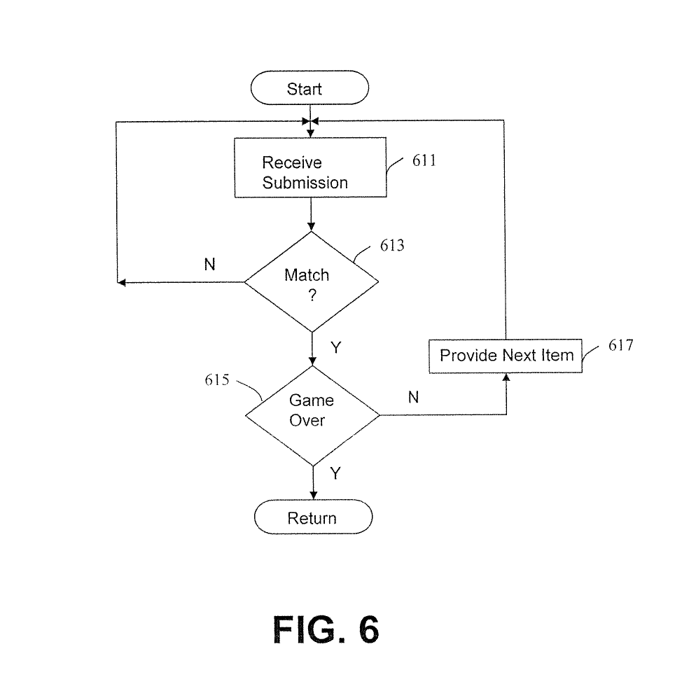

FIG. 6 is a further flow diagram of aspects of game play, for example in a game with sequential provision of target information. In block 611 the process receives a submission from a game player. In block 613 the process determines if the submission, for example an image of what is alleged to be a target item, matches the target item. In block 615 the process determines if the game is over, for example if a player's submissions match all of the target items. If the game is not over, the process provides to the game player information relating to a further item to be found, and returns to block 611. If the game is over the process may simply return.

The invention provides a game for play using communication devices, and embodiments of the invention may include or relate to incidental aspects of such game play. Accordingly, although the invention has been described with respect to various embodiments, it should be realized that the invention comprises the claims and their insubstantial variations supported by this disclosure.

1. A method of providing for a mobile game, comprising:
providing a plurality of clues regarding a plurality of items;
receiving images allegedly of the plurality of items; and
determining a game status based on correspondence between the images and the plurality of items.

2. The method of claim 1 wherein at least one clue of the plurality of clues is provided for each item of the plurality of items.

3. The method of claim 1 wherein the images are images taken by cell phone cameras.

4. The method of claim 1 wherein the plurality of clues are provided to game players.

5. The method of claim 4 wherein at least some of the game players are organized into groups of game players.

6. The method of claim 5 further comprising generating a web page for at least some of the game players or groups of game players.

7. The method of claim 6 further comprising posting received images provided by the at least some of the game players or groups of game players to their web page.

8. The method of claim 1 wherein at least one of the plurality of items is at a predefined location.

9. The method of claim 6 further comprising providing a benefit related to goods or services sold at the predefined location.

10. The method of claim I wherein determining a game status based on correspondence between the images and the plurality of items comprises determining a number of received images that include different ones of the plurality of items in a timed period.

11. The method of claim 1 wherein determining a game status based on correspondence between the images and the plurality of items comprises determining a first game player or group of game players to provide images that together include all of the plurality of items.

12. A system for providing game functions, comprising:
a computer configured by program instructions in memory of the computer to provide clues as to target items to game players using mobile communication devices with imaging capabilities, receive images of alleged target items, record a time of submission of the images, post the images to a web page, and determine a winner of the plurality of game players.

13. The system of claim 12 wherein the program instructions to determine the winner of the plurality of game players configure the computer to determine the winner based time of submission of the images.

14. A method of playing a game, comprising:
receiving information of a plurality of target items;
taking a picture of each of the target items; and
sending each picture to a central unit.

15. The method of claim 14 wherein the information of the plurality of items comprises a clue as to the identity of each of the target items.

16. The method of claim 14 wherein taking a picture of each of the target items comprises taking a picture using a camera of a cell phone of each of the target items.

17. The method of claim 16 wherein at least one of the target items is a retail location.

18. The method of claim 17 further comprising receiving a discount for a good at the retail location.
